(19) United States
(12) Patent Application Publication
(10) Pub. No.: US 2010/0072137 A1
(43) Pub. Date: Mar. 25, 2010

(54) FUNCTIONALIZED GRAPHITIC STATIONARY PHASE AND METHODS FOR MAKING AND USING SAME

(75) Inventors: Matthew R. Linford, Orem, UT (US); David Scott Jensen, Provo, UT (US); Li Yang, Richland, WA (US); Landon Wiest, Provo, UT (US)

Correspondence Address: Workman Nydegger c/o US SYNTHETIC CORP., 60 East South Temple, 1000 Eagle Gate Tower, Salt Lake City, UT, 84111, US

(73) Assignee: BRIGHAM YOUNG UNIVERSITY, Provo, UT (US)

(21) Appl. No.: 12/563,646

(22) Filed: Sep. 21, 2009

Related U.S. Application Data
(60) Provisional application No. 61/192,841, filed on Sep. 22, 2008.
(60) Provisional application No. 61/209,683, filed on Mar. 8, 2009.

(51) Int. Cl. B01J 20/20; B01D 15/08; B01J 20/282; B01J 20/22

(52) U.S. Cl. 210/656; 210/198.2; 210/287; 502/416; 502/401

(57) ABSTRACT

Embodiments disclosed herein include functionalized graphitic stationary phase materials and methods for making and using these materials, including the use of these materials in separation technologies such as, but not limited to, chromatography and solid phase extraction. In an embodiment, a functionalized graphitic stationary phase material may be manufactured from high surface area porous graphitic carbon and a radical forming functionalizing agent. The radical forming functionalizing agent produces an intermediate that forms a covalent bond with the surface of the porous graphitic material and imparts desired properties to the surface of the graphitic carbon.

### CROSS-REFERENCE TO RELATED APPLICATIONS

This application claims the benefit of U.S. Provisional Patent Application No. 61/192,841, entitled “Functionalization of Graphite For Use As A Stationary Phase For Solid Extraction, High Performance Liquid Chromatography, And Ultra Performance Liquid Chromatography,” filed 22 Sep. 2008, and U.S. Provisional Patent Application No. 61/209,683, entitled, “Methods For Functionalizing Graphite For Chromatography,” filed 8 Mar. 2009, both of which are hereby incorporated herein, in their entirety, by this reference.

### BACKGROUND

Chromatography and solid-phase extraction (“SPE”) are commonly-used separation techniques employed in a variety of analytical chemistry and biochemistry environments. Chromatography and SPE are often used for separation, extraction, and analysis of various constituents, or fractions, of a sample of interest. Chromatography and SPE may also be used for the preparation, purification, concentration, and clean-up of samples.

Chromatography and solid phase extraction relate to any of a variety of techniques used to separate complex mixtures based on differential affinities of components of a sample carried by a mobile phase with which the sample flows, and a stationary phase through which the sample passes. Typically, chromatography and solid phase extraction involve the use of a stationary phase that includes an adsorbent packed into a cartridge or column. A commonly-used stationary phase includes a silica-gel-based sorbent material.

Mobile phases are often solvent-based liquids, although gas chromatography typically employs a gaseous mobile phase. Liquid mobile phases may vary significantly in their compositions depending on various characteristics of the sample being analyzed and on the various components sought to be extracted and/or analyzed in the sample. For example, liquid mobile phases may vary significantly in pH and solvent properties. Additionally, liquid mobile phases may vary in their compositions depending on the characteristics of the stationary phase that is being employed. Often, several different mobile phases are employed during a given chromatography or SPE procedure. Stationary phase materials may also exhibit poor stability characteristics in the presence of various mobile phase compositions and/or complex mixtures for which separation is desired. The poor stability characteristics of stationary phase materials in some mobile phases and complex mixtures, in some cases, may even preclude the possibility of using chromatography or solid phase extraction to perform the desired separation.

High surface area porous graphitic carbon, also referred to herein as “HSAPGC” and “porous graphitic carbon,” has many unique properties such as chemical and thermal stability, thermal conductivity, and polarizability, which makes it useful for liquid chromatography. Since the surface of graphite is polarizable, the retention mechanism of porous graphitic carbon is a charge-induced interaction between itself and other polar analytes.

### SUMMARY

Embodiments disclosed herein include functionalized graphitic stationary phase materials and methods for making and using these materials, including the use of these materials in separation technologies such as, but not limited to, chromatography and solid phase extraction. In an embodiment, a functionalized graphitic stationary phase material may be manufactured from high surface area porous graphitic carbon and a radical forming functionalizing agent. The radical forming functionalizing agent produces an intermediate that forms a covalent bond with the surface of the porous graphitic material and imparts desired properties to the surface of the graphitic carbon. For example, a plurality of alkyl-group-containing functional group molecules may be covalently bonded to the surface of the porous graphitic carbon. The functionalized graphitic stationary phase material may have unique selectivity and good thermal and chemical stability.

In one embodiment, a method for manufacturing a functionalized graphitic stationary phase material includes providing a high surface area porous graphitic carbon having a porosity and surface area suitable for use as a stationary phase. The method also includes providing a functionalizing agent capable of forming a radical that may form a covalent bond with graphitic carbon. The functionalizing agent is caused to form a radical intermediate and reacted with the porous graphitic carbon. The radical intermediate forms a covalent bond with the surface of the porous graphitic material, thereby yielding the functionalized graphitic stationary phase material.

The radical forming functionalizing agent may include one or more alkyl groups and optionally one or more heteroatoms. For example, in one embodiment, the radical forming agent may be an alkyl halide. The step of forming the radical intermediate may be promoted using heat, light, chemicals, or combinations of the foregoing.

In another embodiment, a separation apparatus for performing chromatography or solid phase separation is described. The separation apparatus includes a vessel having an inlet and an outlet. Any of the functionalized graphitic stationary phase materials disclosed herein may be disposed within the vessel. The vessel may be a column or a cassette suitable for use in the fields of chromatography and/or solid phase separation (e.g., high performance liquid chromatography (“HPLC”)).

The separation apparatus may be used to physically separate different components from one another. In one embodiment, a mobile phase including at least two different components to be separated is caused to flow through the functionalized graphitic stationary phase material to physically separate the at least two different components. At least one of the two different components is recovered.

The functionalized stationary phase material may be used in some embodiments with a mobile phase that would typically degrade commonly used stationary phase materials, such as a silica gel. For example, the mobile phase may include organic solvents, and/or highly acid or highly basic solvents (e.g., pH greater than 10 or less than 2).

Features from any of the disclosed embodiments may be used in combination with one another, without limitation. In addition, other features and advantages of the present disclosure will become apparent to those of ordinary skill in the art through consideration of the following detailed description and the accompanying drawings.

### BRIEF DESCRIPTION OF THE DRAWINGS

The drawings illustrate several embodiments of the invention, wherein identical reference numerals refer to identical elements or features in different views or embodiments shown in the drawings.

FIG. 1 is a flow diagram of a method for manufacturing a functionalized graphitic stationary phase according to an embodiment;

FIG. 2 is a cross-sectional view of an embodiment of a separation apparatus including any of the functionalized graphitic stationary phase materials disclosed herein;

FIG. 3 is a time-of-flight secondary ion mass spectrometry spectra (“ToF-SIMS”) of a functionalized graphitic stationary phase material of Example 1;

FIG. 4 is an X-ray photoelectron spectroscopy (“XPS”) spectrum of a functionalized graphitic stationary phase material manufactured according to Example 1;

FIGS. 5-6 illustrate the spectral data and tabular data of a separation procedure carried out using a functionalized graphitic stationary phase material manufactured according to Examples 3 and 4, respectively;

FIG. 7 illustrates the spectral data and tabular data of a separation procedure carried out using a non-functionalized graphitic stationary phase material in a comparative Example 5;

FIG. 8 is an XPS spectrum of a functionalized graphitic stationary phase material of Example 6;

FIGS. 9-10 are ToF-SIMS spectra of a functionalized graphitic stationary phase material of Example 7;

FIG. 11 is a diffuse reflectance infrared Fourier transform spectroscopy (“DRIFT”) data for the functionalized graphitic stationary phase material of Example 7;

FIG. 12 shows a table of infrared spectroscopy analysis of the functionalized graphitic stationary phase material of Example 7; and

FIGS. 13-14 are ToF-SIMS spectra of a functionalized graphitic stationary phase material of Example 8.

### DETAILED DESCRIPTION

Embodiments disclosed herein are directed to functionalized graphitic stationary phase materials, methods for making such materials, and separation apparatuses (e.g., chromatography and solid-phase extraction apparatuses) and separation methods that employ such functionalized graphitic stationary phases.

### I. COMPONENTS USED TO MAKE POROUS COMPOSITE PARTICULATE MATERIALS

Components useful for manufacturing the functionalized graphitic stationary phase material include, but are not limited to, high surface are porous graphitic carbon and radical forming functionalizing agents.

### High Surface Area Porous Graphitic Carbon

The functionalized graphitic material may be manufactured using a high surface area porous graphitic carbon. The high surface area porous graphitic carbon includes graphite, which is a three-dimensional hexagonal crystalline long range ordered carbon that can be detected by diffraction methods. In one embodiment the high surface area porous graphitic carbon is mostly graphite or even substantially all graphite. The surface of the porous graphitic carbon may include domains of hexagonally arranged sheets of carbon atoms that impart aromatic properties to the carbon. In other embodiments, the functionalized graphitic material may also include non-graphitic carbon (e.g., amorphous carbon) in addition to the high surface area graphitic carbon. The graphitic nature of the porous graphitic carbon provides chemical and thermal stability in the presence of traditionally harsh solvents such as organic solvents and highly acidic or highly basic solvents.

The functionalized graphitic material exhibits an average particle size, porosity, and surface area suitable for use in separation techniques such as chromatography and solid phase separation. In an embodiment, the porous graphitic material may have an average particle size that is in a range from about 1 μm to about 500 μm, more specifically about 1 μm to about 200 μm, or even more specifically in a range from about 1 μm to about 100 μm. The desired average particle size may depend on the application in which the stationary phase is to be used. In one embodiment, the porous graphitic carbon particles have an average particle size in a range from about 1 μm to 10 μm, more specifically about 1.5 μm to about 7 μm. This range may be suitable for HPLC applications and the like. In another embodiment, the average particle size may be in a range from about 5 μm to about 500 μm, or more specifically in a range from about 10 μm to about 150 μm. This larger range may be suitable for solid phase extraction applications and the like.

The high surface area porous carbon may be manufactured using any technique that provides the desired surface area, particle size, and graphitic content. In one embodiment, porous graphitic carbon can be prepared by impregnating a silica gel template with phenol-formaldehyde resin, followed by carbonization of the silica-resin composite, dissolution of the silica to form a porous carbon intermediate, and finally graphitization of the porous carbon intermediate to form porous graphitic carbon. This process produces a 2-dimensional crystalline surface of hexagonally arranged carbon atoms over at least some surfaces of the porous carbon intermediate. Its pore structure may be similar to that of the original silica template. The open pore structure may provide the porous graphitic carbon mass transfer properties comparable to those of silica gels but with superior structural integrity and resistance to chemical degradation.

### Radical Forming Functionalizing Agents

The methods for manufacturing the functionalized graphitic stationary phase material include the use of a radical forming functionalizing agent. The radical forming functionalizing agent includes one or more alkyl groups and optionally one or more heteroatoms. When bonded to the surface of the porous graphitic carbon, the alkyl and heteroatoms bonded thereto impart properties that are desirable for separating components of a mobile phase. The functionalizing agent is selected to be capable of forming a radical intermediate that can react with and form a covalent bond with the graphitic surface of the high surface area porous graphitic carbon.

In one embodiment, the radical forming functionalizing agent forms a carbon radical intermediate that may form a sp³ hybridized bond with one of the hexagonally arranged carbon atoms in the graphitic surface of the porous graphitic carbon material.

Several types of radical forming compounds may be used as radical forming functionalizing agents. In one embodiment, the radical forming agent may be a compound typically used in polymerization reactions as an initiator. In some embodiments, the radical forming functionalizing agent may be a compound that decomposes to form one or more radical species. The decomposition of the radical forming agent may be caused by heat, light, and/or chemical activators.

Examples of compounds that may be used as radical forming functionalizing agents include, but are not limited to, alkyl halides, aredi-tert-amylperoxide, azobisisobutyronitrile (“AIBN”), benzoyl peroxide, diacyl peroxides, and similar compounds. In one embodiment, the radical forming functionalizing agent may be a “Vazo free” radical source sold by DuPont (USA). The DuPont Vazo® free radical sources are substituted azonitrile compounds that thermally decompose to generate two free radicals per molecule and evolve gaseous nitrogen. The rate of decomposition is first-order and is unaffected by the presence of metal ions.

In the case where the functionalizing agent includes one or more heteroatoms, the heteroatoms may be bonded to an alkyl group. The alkyl group may be substituted or unsubstituted straight chain, branched or cyclic alkyl groups. In one embodiment, the alkyl group may include a ring structure with aromaticity. The one or more heteroatoms may be one or more halides.

In some cases the functionalizing agent may be a halogen-substituted or polyhalogen-substituted alkane or benzene. In one embodiment, the halogen substituted compound is a fluorinated alkyl compound. Examples of halogen-substituted alkyl compounds include perfluorinated substituents or compounds with the formula R_{f}X where R_{f} is a fluorinated alkyl group and X is chlorine, bromine, or iodine. A more specific, but non-limiting example of a perfluorinated alkyl compound is heptadecafluoro-1-iodooctane. Thermolysis of the X component of R_{f}X produces an R_{f} radical that can create a sp³ bond with the porous graphitic carbon.

Another example of a perfluoro alkyl compound that may be used is a polyfluorobenzene compound. In this case, the R_{f} moiety includes a benzene ring. A more specific, non-limiting example of a polyfluorobenzene compound that may be used is pentafluoroiodobenzene.

In another embodiment, the functionalizing agent may be a perfluoronate compound (R_{f}COO⁻M⁺). At elevated temperatures the R_{f}COO⁻M⁺ compound undergoes decarboxylation which produces CO₂ and radical R_{f} species. The radical species reacts with the porous graphitic carbon to produce a sp³ linkage between the graphite and R_{f} molecule.

In yet another embodiment, the functionalizing agent may be a perfluorinated azo compound (R_{f}N₂). Thermolysis of the carbon-nitrogen bond occurs at elevated temperatures, which produces N₂ and R_{f} radicals. The resulting R_{f} radicals react with the porous graphitic carbon to produce sp³ linkages between the graphite and the R_{f} molecules.

The radical producing functionalizing agent may be caused to form a radical using heat, light, chemical agents, or a combination of the foregoing. In a specific embodiment, the temperature at which a radical forms is at least about 150° C. and more specifically at least about 200° C. Generally, the temperature at which radical formation occurs and/or the wavelength that causes radical formation, and/or the chemicals that cause radical formation may be specific to the particular radical forming compound.

### II. METHODS FOR MAKING FUNCTIONALIZED GRAPHITIC STATIONARY PHASE

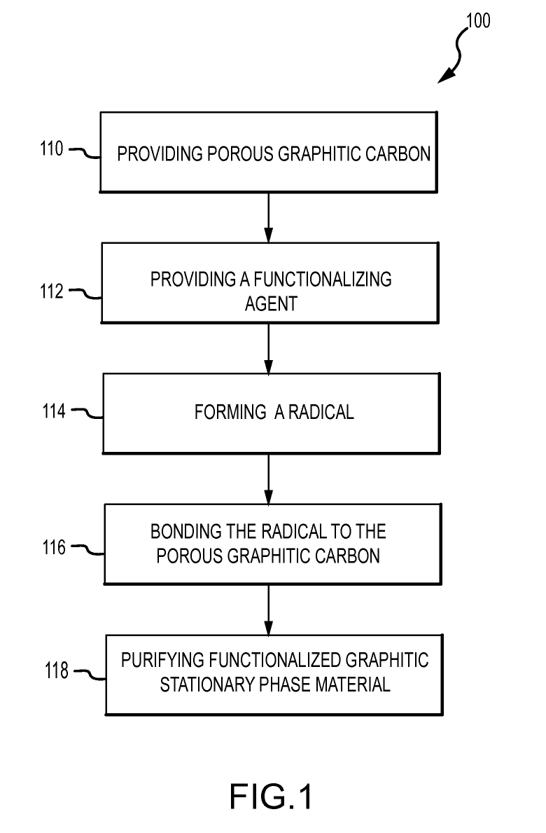

Reference is now made to FIG. 1 which illustrates a flow diagram 100 of an embodiment of a method for making functionalized graphitic stationary phase materials. Steps 110 and 112 include providing a porous graphitic carbon and a radical forming agent, respectively. The porous graphitic carbon and radical forming agent may be any of those described above or compounds that provide a similar functionality as the materials mentioned herein.

In step 114, a radical intermediate is formed from the radical forming functionalizing agent. The particular way in which the radical may be formed depends on the nature of the particular functionalizing agent. Functionalizing agents suitable for use in the methods described herein may be activated by heat, light, chemical activators, or combinations of the foregoing. In many cases, the functionalizing agent decomposes in the presence of the heat, light, and/or chemical activator and/or under goes a change involving the loss of the radical forming moiety. The decomposition typically produces a reactive radical intermediate suitable for covalently bonding with the graphitic surface and produces a non-functionalizing radical that then forms a non-reactive species. Examples of relatively non-reactive species that may form during the reaction include, but are not limited to, nitrogen gas, carbon dioxide gas, and metal halides.

In one embodiment, an activating agent can be used in combination with the functionalizing agent to promote formation of the radical intermediate. In one embodiment, the activating agent may include a metal such as, but not limited to, 1B metals including copper, silver, and/or gold. Metal activating agents may be used in combination with polyfluoro-alkyl compounds to form radicals. In one non-limiting example, a 1B metal such as copper may be used with a fluorinated alkyl compound such as, but not limited to, pentafluoroiodobenzene to enhance perfluoroalkylation. The 1B metal can also act as a scavenger of undesired radicals. The reaction scheme below is currently believed to be the route of perfluorination with pentafluoriodobenzene and copper:

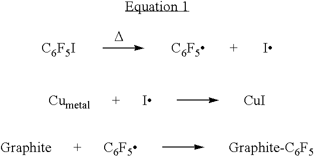

In one embodiment, the use of heat to form a radical may be beneficial to ensure relatively even distribution of the formation of the radical within the pores of the porous graphitic carbon. Even distribution of the functionalization of the porous graphitic carbon may help achieve high separation efficiency in chromatography and solid phase extraction procedures using the functionalized graphitic material.

In one embodiment, the formation of the radical intermediate can be carried out at a temperature of at least about 150° C., more specifically at least about 200° C. In one embodiment, the radical intermediate is formed at a temperature in a range from about 150° C. to about 500° C., more specifically in a range from about 200° C. to about 300° C. Other temperatures can be used so long as the temperature is sufficient to cause thermolysis of the radical producing functionalizing agent, if applicable.

In the case where the radical producing functional agent is a light activated compound, the intermediate may be formed by exposing the light to the particular wavelength that causes photolysis of the functionalizing agent. The particular wavelength that induces radical formation is generally specific to the particular functionalizing agent.

In one embodiment, the reaction may be carried out in an inert environment. For example, the reaction mixture and/or chamber may be purged with argon, nitrogen, or another suitable inert gas to remove oxygen. Removing oxygen from the reaction mixture and/or reaction chamber advantageously minimizes the formation of oxygen functional groups on the surface of the graphite (e.g., minimizes formation of hydroxyl and carboxyl groups). The reaction vessel may also be vacuumed to evacuate undesired reactive species.

In Step 116 of method 100, the radical intermediate reacts with the porous graphitic carbon. This step is generally carried out by mixing the radical intermediate with the porous graphitic carbon. The stoichiometric amount of radical agent molecules (i.e, functionalizing agent molecules) per carbon atom in the porous graphitic carbon may be at least about 3 (i.e., a ratio of about 3:1), more specifically at least about 4 (i.e., a ratio of about 4:1).

The radical intermediates are highly reactive and form a covalent bond with the carbon in the graphitic sheet on the surface of the porous graphitic carbon. The formation of the covalent bond consumes the radical intermediate and yields the functionalized graphitic stationary phase material. The reaction components are allowed to react for a sufficient time to obtain the desired functionalization at a desired yield. The concentration of the functionalizing agent and the duration of the reaction determine the extent of functionalization. In one embodiment, the functionalization step is allowed to proceed for at least 8 hours, more specifically at least 24 hours, or even more specifically at least about 48 hours.

The radical intermediate is typically formed in the presence of the graphitic porous carbon due to the ephemeral nature of radicals. For example, the functionalizing agent may be introduced into a furnace (e.g., a tube furnace) with the porous graphitic carbon and then heated to form the radical intermediate. However, forming the radical in the presence of the porous graphitic carbon is not required so long as the radical intermediate lasts long enough to react with the porous graphitic carbon once the two materials are brought into contact.

Step 116 may be carried out in an inert environment to prevent oxygen from reacting with the carbon in the porous graphitic carbon. This may be particularly important in reactions where the temperature is elevated. Oxygen can be removed from the reaction mixture by purging the reaction vessel with an inert gas such as, but not limited to, argon and/or nitrogen.

In one embodiment, the radical producing agent may form a start site on the graphite where polymerization may occur. In one embodiment, the surface of the porous graphitic carbon is functionalized by hydrogen reduction. The graphitic material may be exposed to a hydrogen plasma to hydrogen terminate the carbon (i.e., to create C—H bonds in the graphitic material), to a water plasma to introduce hydroxyl moieties onto the graphitic material, to a chlorine plasma, or combinations of the foregoing. Further methods include creating an initiation site for atom transfer radical polymerization, which may formed on a graphite edge or face. ATRP or another type of living polymerization may be allowed to proceed from this site to produce covalently bonded functional groups on the surface of the porous graphitic carbon. Polymers covalently bonded to the porous graphitic carbon may also be cross-linked using known methods.

In step 118, the functionalized graphitic stationary phase material may be purified, if needed. The purification step 118 may include collecting the reaction product and heating the reaction product in a vacuum to evaporate non-bonded reagents such as, but not limited to, residual radical forming functionalizing agent. In one embodiment, the functionalized graphitic stationary phase can be heated at a temperature of at least about 60° C., more specifically at least about 70° C. for at least about 2 hours, more specifically at least about 12 hours, and even more specifically at least about 24 hours. The reaction product can also be cleaned using solvents. For example, the functionalized graphitic stationary phase material can be cleaned by Soxhlet extraction with perfluorohexane. Cleaning with a solvent can be carried out for at least 2 hours, more specifically at least 12 hours, and even more specifically at least 24 hours.

### III. FUNCTIONALIZED GRAPHITIC STATIONARY PHASE

The functionalized graphitic stationary phase materials described herein provide desired sizes, porosity, surface areas, and chemical stability suitable for chromatography and solid phase extraction techniques. When used in chromatography and solid phase extraction, high-resolution separation may be achieved with relatively low back pressure.

The functionalized graphitic stationary phase materials may be provided in the form of finely divided discrete particles (e.g., a powder). Alternatively, the functionalized graphitic stationary phase materials may be provided as a monolithic structure having a porosity and surface area that is similar to finely divided discrete particles. When the functionalized graphitic stationary phase materials are provided as a monolithic structure, the body may exhibit dimensions suitable for use in a separation apparatus, such as, but not limited to, separation devices used in HPLC.

In one embodiment, the functionalized graphitic stationary phase material includes a plurality of graphitic particles having an average particle size in a range from about 1 μm to 500 μm, more specifically about 1 μm to 200 μm, or even more specifically in a range from about 1 μm to about 150 μm. In one embodiment, the functionalized graphitic stationary phase materials have an average particle size in a range from about 1 μm to about 10 μm, or more specifically about 1.5 μm to about 7 μm. This particle range may be particularly useful for HPLC applications and the like. In another embodiment, the functionalized graphitic stationary phase materials may have an average particle size in a range from about 5 μm to about 500 μm, or more specifically in a range from about 10 μm to about 150 μm. This larger average particle range may be more suitable for use in solid phase extraction applications and the like.

The functionalized graphitic stationary phase materials may include a desired surface area. The surface area per unit weight of the functionalized graphitic stationary phase materials depends to a large extent on the surface area of the porous graphitic carbon used to manufacture the functionalized graphitic stationary phase materials. In an embodiment, the surface area per unit weight may be measured using the Brunauer Emmett and Teller (“BET”) technique and is in a range from 1-500 m²/g for functionalized graphitic stationary phase materials having a particle size in a range from about 1 μm to 500 μm, more specifically in a range from 25-300 m²/g, or even more specifically 50-200 m²/g. In one embodiment, the functionalized graphitic stationary phase materials have a particle size in a range from about 1 μm to 10 μm and may have a surface area per unit weight in a range from about 10-500 m²/g, more specifically in a range from 25-200 m²/g, and even more specifically in a range from 25-60 m²/g. In another embodiment, functionalized graphitic stationary phase materials having a particle size from about 10 μm to 150 μm may have a surface area per unit weight in a range from about 5-200 m²/g, or more specifically 10-100 m²/g. In yet another embodiment, functionalized graphitic stationary phase materials having an average particle size in a range from about 250 μm to about 500 μm may have a surface area per unit weight of at least about 5 m²/g, and even more specifically at least about 10 m²/g for functionalized graphitic stationary phase materials with an average particle size in a range from about 250 μm to about 500 μm.

The surface of the functionalized graphitic stationary phase materials differs from porous graphitic carbon in significant ways. The functionalized graphitic stationary phases described herein include alkyl functional groups that are bonded (e.g., covalently bonded) to the graphitic carbon. For example, the surface of the graphitic carbon may include substantially only graphene or may be partially graphene, with the alkyl groups extending away from the graphene at an angle to the surface of the graphitic carbon. For example, the angle at which the alkyl groups extend away from the graphene may be substantially perpendicular.

The functional groups provide physical differences in the molecular structure of the surface of the porous graphitic carbon and may have a significant impact on separation efficiencies. In addition, the one or more alkyl groups and optional heteroatoms may provide unique electrical properties that cause the surface to interact with solvents and solutes differently than a pure graphitic surface. Because the functional groups are covalently bonded, the functional groups can withstand relatively harsh conditions, thereby avoiding leaching or undesired reactions with solvents and/or solutes. These differences allow the functionalized stationary phases described herein to be used as a stationary phase for separating materials that cannot be separated with pure porous graphitic carbon. In various embodiments, the amount of the surface area of the porous graphitic carbon that is covalently bonded with the alkyl functional groups may be about 10 percent to about 98 percent, about 25 percent to about 95 percent, about 50 percent to about 90 percent, or about 75 percent to about 98 percent.

The particular properties that the covalently bonded functional groups impart to the functionalized graphitic stationary phase material may depend on the particular functional groups. In one embodiment, the functional groups bonded to the graphitic carbon may be similar to the radical producing agent molecules described above, but may differ with respect to the radical producing moiety. For example, the radical forming agent may lose a halogen radical, nitrogen radical, or carbon radical in the formation of the radical intermediate. Thus, the functional groups bonded to the graphitic carbon may include the one or more alkyl groups and optionally one or more heteroatoms from the radical producing functionalizing agent molecules, but not the radical forming moiety.

In one embodiment, the functional groups may include alkyl groups having two or more carbons, more specifically 4 or more carbons, and even more specifically 6 or more carbons. The alkyl groups may include ring structures of 4 or more atoms, more specifically 6 or more atoms. In one embodiment, the ring structures may be aromatic. In one embodiment, the functional group may be an alkyl halide. Examples of alkyl halides that may be exhibited on the surface of the graphitic carbon include, but are not limited to, perfluoroalkyl groups and polyfluorobenzene groups. More specifically, the alkyl halide may include a heptadecafluoro octane group and/or a pentafluorobenzene group.

The extent of functionalization (i.e., the number of functionalizing agent molecules on the graphitic surface) is at least sufficient to cause an appreciable difference in the separation characteristics of the functionalized graphitic stationary phase as compared to non-functionalized porous graphitic carbon. In one embodiment, the extent of functionalization may be measured according to the atomic weight percent of one or more atoms in the functional group as a total atomic weight percent of the stationary phase material. In one embodiment, the atomic weight percent of the functional groups is at least about 1 atom %, more specifically at least about 5 atom % or even more specifically at least about 10 atom %, or yet even more specifically at least about 20 atom %.

In one embodiment, the amount of oxygen on the surface of porous graphitic carbon is limited. In this embodiment, the atomic weight percent of oxygen in the stationary phase is less than about 25 atom %, more specifically less than 20 atom % and even more specifically less than about 15 atom %. In one embodiment, the atomic weight percent of functional group atoms other than oxygen is greater than the atom % of oxygen in the stationary phase. In one embodiment, the atomic weight percent of functional group atoms other than oxygen is at least about twice that of the atomic weight percent of oxygen in the stationary phase material.

The covalent functionalization of the graphitic surface with the one or more alkyl groups and optional heteroatoms is sufficiently extensive to cause an appreciable difference in the separation efficiency of a separation apparatus incorporating the functionalized graphite stationary phase materials as compared to non-functionalized porous graphitic carbon.

### IV. SEPARATION APPARATUSES AND METHODS

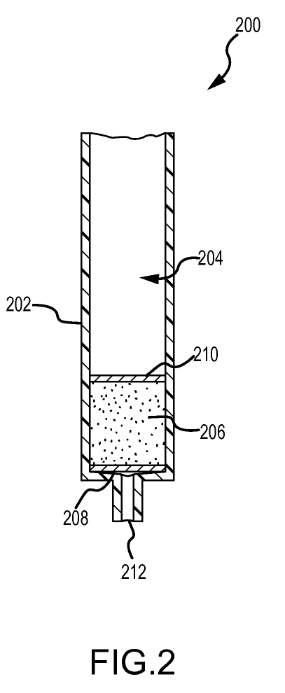

FIG. 2 is a cross-sectional view of a separation apparatus 200 according to an embodiment. The separation apparatus 200 may include a column 202 defining a reservoir 204. A porous body 206 (e.g., a porous composite bed, porous disk, other porous mass, etc.) may be disposed within at least a portion of the reservoir 204 of the column 202. The porous body 206 may comprise any of the functionalized graphitic stationary phase materials disclosed herein. The porous body 206 is porous so that a mobile phase may flow therethrough. In various embodiments, a fit 208 and/or a fit 210 may be disposed in column 202 on either side of porous body 206. The fits 208 and 210 may comprise any suitable material that allows passage of a mobile phase and any solutes present in the mobile phase, while preventing passage of the functionalized graphitic stationary phase materials present in porous body 206. Examples of materials used to form the fits 208 and 210 include, without limitation, glass, polypropylene, polyethylene, stainless steel, polytetrafluoroethylene, or combinations of the foregoing.

The column 202 may comprise any type of column or other device suitable for use in separation processes such as chromatography and/or solid phase extraction processes. Examples of the column 202 include, without limitation, chromatographic and solid phase extraction columns, tubes, syringes, cartridges (e.g., in-line cartridges), and plates containing multiple extraction wells (e.g., 96-well plates). The reservoir 204 may be defined within an interior portion of the column 202. The reservoir 204 may permit passage of various materials, including various solutions and/or solvents used in chromatographic and/or solid-phase extraction processes.

The porous body 206 may be disposed within at least a portion of reservoir 204 of the column 202 so that various solutions and solvents introduced into the column 202 to contact at least a portion of the porous body 206. The porous body 206 may comprise a plurality of substantially non-porous particles in addition to the composite porous material.

In certain embodiments, frits, such as glass frits, may be positioned within the reservoir 204 to hold porous body 206 in place, while allowing passage of various materials such as solutions and/or solvents. In some embodiments, a frit may not be necessary, such as where a monolithic functionalized graphitic stationary phase is used.

In one embodiment, the separation apparatus 200 is used to separate two or more components in a mobile phase by causing the mobile phase to flow through the porous body 206. The mobile phase is introduced through an inlet and caused to flow through the porous body 206 and the separated components may be recovered from the outlet 212.

In one embodiment, the mobile phase includes concentrated organic solvents, acids, or bases. In one embodiment, the mobile phase includes a concentrated acid with a pH less than about 3, more specifically less than about 2. In another embodiment, the mobile phase includes a base with a pH greater than about 10, more specifically greater than about 12, and even more particularly greater than 13.

In one embodiment, the separation apparatus 200 is washed between a plurality of different runs where samples of mixed components are separated. In one embodiment, the washing may be performed with water. In another embodiment, a harsh cleaning solvent is used. In this embodiment, the harsh cleaning solvent may be a concentrated organic solvent and/or a strong acid or base. In one embodiment, the cleaning solvent has a pH less than about 3, more specifically less than about 2. In another embodiment, the cleaning solvent has a pH greater than about 10, more specifically greater than about 12, and even more particularly greater than 13.

### V. EXAMPLES

The following examples are for illustrative purposes only and are not meant to be limiting with regards to the scope of the specification or the appended claims.

### Example 1

Example 1 describes the synthesis of a functionalized graphitic stationary phase material using pentafluoroiodobenzene and copper as an activating agent.

High surface area porous graphite was provided by Thermo Fisher (Hypercarb®) and was reacted with pentafluoroiodobenzene (98%, SynQuest Laboratories) under an argon atmosphere in copper tubing fitted with Swagelok brass caps. The reaction was carried out at 260° C. to cause homolytic cleavage between the carbon-iodine bond, thereby forming a radial intermediate that reacted with the porous graphitic carbon. Each reaction was carried out for 96 hours.

The reaction product was removed from the reaction vessel and placed into a vacuum oven and heated at 70° C. for 24 hours in order to evaporate non-bonded perfluorinated moieties from the product surface. The product was then cleaned by Soxhlet extraction with perfluorohexane for 24 hrs.

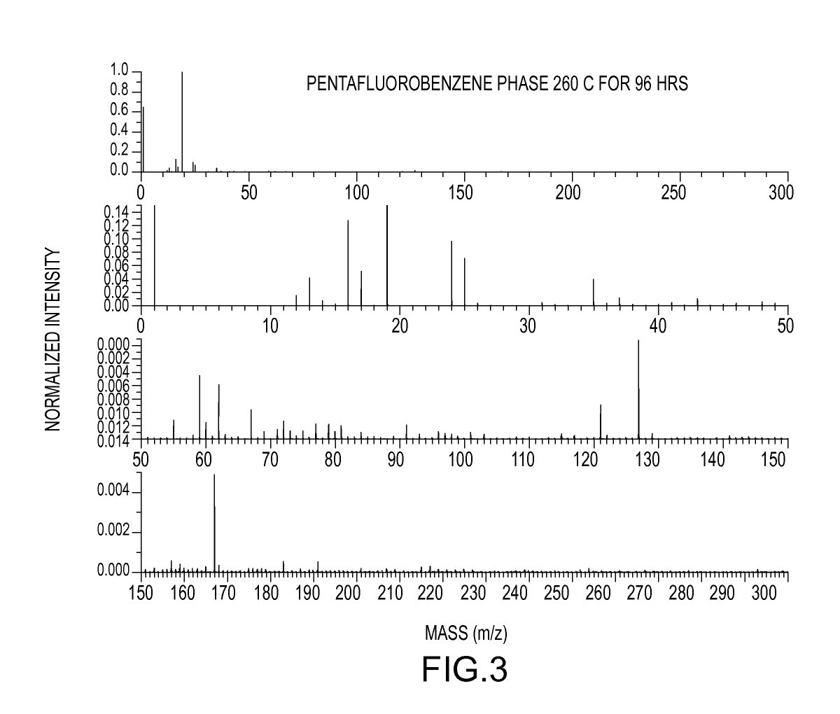

The reacted graphite sample was characterized by XPS and ToF-SIMS. The ToF-SIMS spectra for Examples 1 is shown in FIG. 3. Major peaks in the spectra for Example 1 are: 19 m/z=F, 31 m/z=CF, 43 m/z=C₂F, 55 m/z=C₃F, 127 m/z=I, 129 m/z=C₆F₃, and 167 m/z=C₆F₅. Two peaks that are of interest include the peak at about 19 m/z (fluorine ion) and the peak at about 167 m/z (C₆F₅ ion). Each spectrum was normalized to the fluorine peak. The sample prepared in Example 1 (i.e., at 260° C.) shows a higher degree of functionalization as the area under the C₆F₅. The peak area for Example 1 was 0.01903,

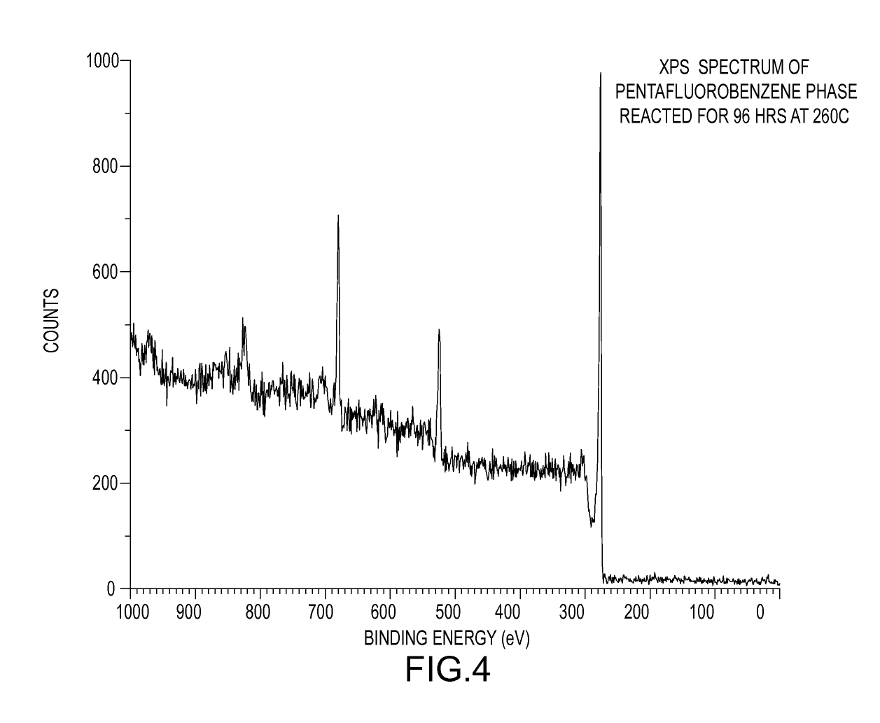

XPS data that was obtained for Example 1 is shown in FIG. 4. The atom percent composition of the functionalized stationary phase of Example 1 was: 70% Carbon, 1.4% Fluorine, 28% Oxygen, 0.5% Copper, and 0.1% Iodine.

### Example 2

Example 2 describes the synthesis of a functionalized graphitic stationary phase material using azobisisobutylnitrile (AIBN).

High surface area porous graphitic carbon was provided by Thermo Fisher (Hypercarb®) and was reacted with azobisisobutylnitrile (AIBN) (98%, Sigma-Aldrich) under a nitrogen purged atmosphere. 1.5 g of high surface area porous graphitic carbon and 1 g of AIBN were mixed into 60 ml of toluene that was previously purged with nitrogen (this solution was purged thought the reaction). The reaction was carried out at 80° C. for 24 hrs. At temperatures above 60° C. the AIBN undergoes homolytic cleavage at the carbon-nitrogen bond producing two 2-cyanoprop-2-yl radicals and nitrogen gas as follows:

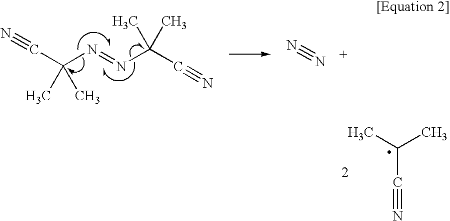

The resulting 2-cyanoprop-2-yl radicals react with the graphite to produce a 2-cyanoprop-2-yl bonded phase. The nitrile on the 2-cyanoprop-2-yl can act as a site for further functionalization. The reaction product was removed from the reaction vessel and washed for 1 day in a soxhlet extractor with toluene as the cleaning agent.

The product of Example 2 was characterized by XPS and ToF-SIMS. Two peaks are of interest in the negative ion mode were at about 14 m/z (nitrogen ion) and about 26 m/z (CN ion).

### Example 3

Example 3 describes the use of the functionalized stationary phase of Example 1 in an HPLC column and separation apparatus. The product from Examples 1 was packed into a 50×4.6 mm HPLC column with 5 micrograms of graphitic stationary phase material. The HPLC procedure was carried out using a mobile phase with 95:5 Methanol:H₂O, a flow rate of 0.8 ml/min, and a sample volume of 7 μL. Spectral analysis was performed at 254 nm. The following chemical species were used to evaluate the chromatographic efficiency of the HPLC column of Example 3: acetone (dead time marker), phenol, anisole, paracresol, phenetole, and 3,5 xylenol.

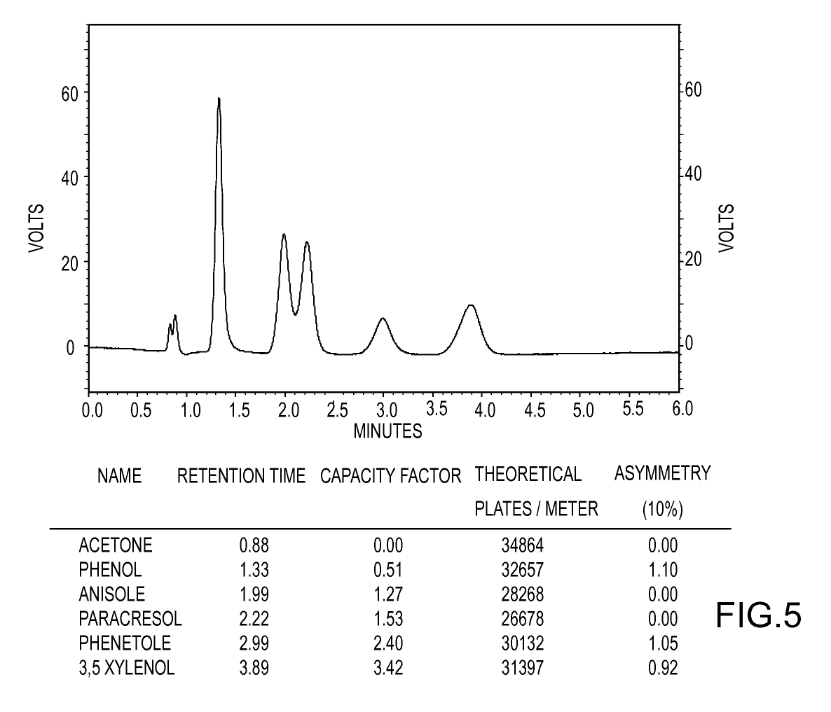

The resulting chromatogram for Example 3 is shown in FIG. 5. The table in FIG. 5 lists the chemical that was separated, the retention time, the capacity factor, theoretical plates/meter, and asymmetry for Examples 3. Higher theoretical plates/meter is an indication of better separation efficiency for a stationary phase under the tested conditions.

### Example 4

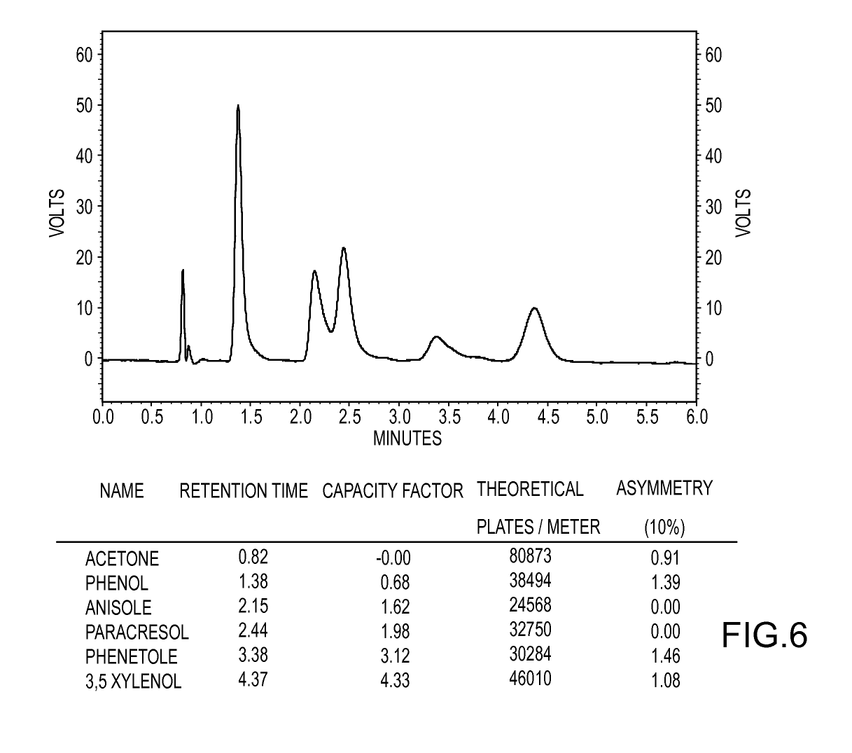

Example 4 describes the use of the functionalized stationary phase of Example 2 in an HPLC column and separation apparatus. Example 4 was carried out the same as Example 3, except that the HPLC column was packed with the functionalized stationary phase from Example 2. The resulting chromatogram for Example 4 is shown in FIG. 6.

### Example 5

Example 5 is a comparative example showing the use of commercially available Hypercarb® to perform the same separation as Examples 3 and 4. The non-functionalized starting material used in Examples 1 and 2 (i.e., Hypercarb®) was packed into a column to make comparative Example 5. The separation procedure for Example 5 was carried out similar to Example 1 except for the use of Hypercarb instead of functionalized graphitic stationary phase.

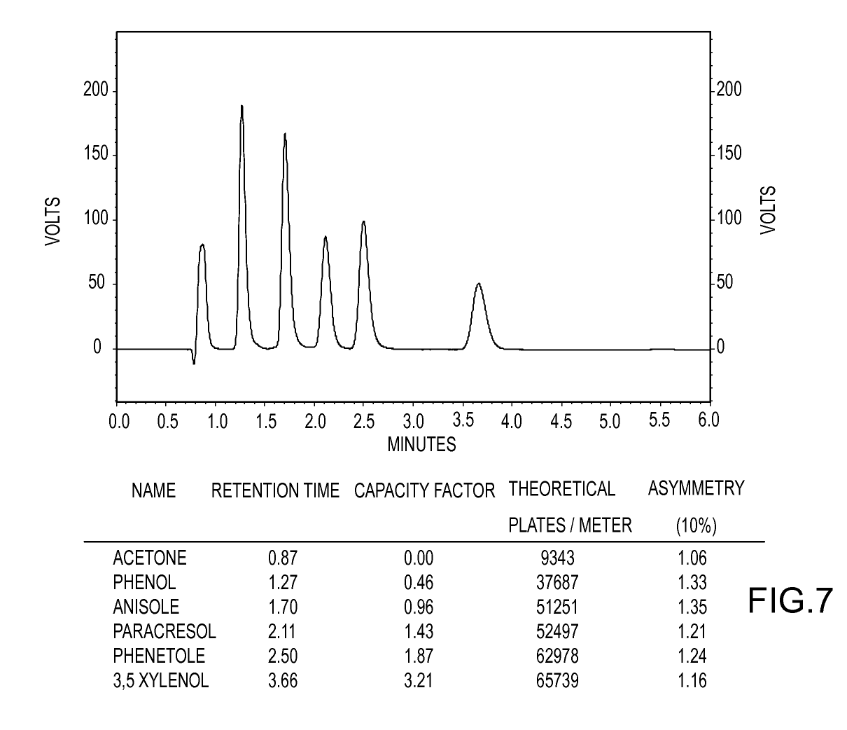

The resulting chromatogram for Examples 5 is shown in FIG. 7. As shown in the chromatograms and tables in FIGS. 5-7, the functionalized stationary phases described herein clearly have different separation characteristics compared to Hypercarb. Surprisingly, the AIBN functionalized stationary phase of Example 2 performed substantially better than Hypercarb as evidenced by the improvement in the number of theoretical plates achieved for Example 4 for certain chemicals. This is surprising because the separation procedure used was optimized for Hypercarb, not the functionalized stationary phases of Examples 1 and 2.

### Example 6

Example 6 describes a method for making a functionalized graphitic stationary phase material similar to Example 1, except that the reaction step was carried out twice (in series).

The method was carried out identical to Example 1. Then, the functionalized porous graphitic material was functionalized a second time using the same materials and reaction conditions except that the porous graphitic material had already been functionalized. In addition, care was taken to eliminate oxygen from the reactants. The pentafluoroiodobenzene was degassed through a freeze pump thaw procedure due to its high affinity towards oxygen and later back filled with argon in order to eliminate any oxygen that might have dissolved in the reagent.

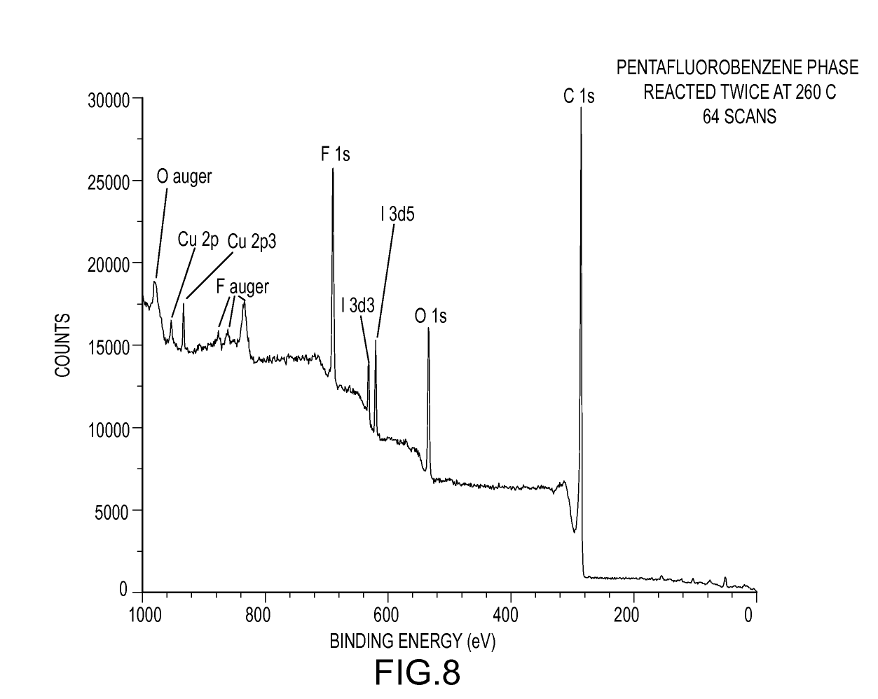

The functionalization in Example 6 was surprisingly greater than expected. FIG. 8 provides the XPS data for Example 6, which confirms that the above reaction condition increased the amount of fluorine in the sample by approximately nine times compared to the XPS data that was obtained for the single reaction 260° C. sample shown in FIG. 4. The atomic weight percent for the product of Example 6 was 73% Carbon, 12.6% Fluorine, 12.7% Oxygen, 0.7% Copper, and 0.9% Iodine.

### Example 7

Example 7 describes the synthesis of a functionalized graphitic stationary phase material using heptadecafluoro-1-iodooctane. High surface area porous graphitic carbon (Thermo-Fisher) was reacted with heptadecafluoro-1-iodooctane (98%, Sigma-Aldrich) in a stainless steel vessel (Sagelock) under an argon atmosphere. Copper (>99% purity) was added to increase the degree of perfluoroalkylation and to decrease iodine contamination. The vessel was placed into a benchtop muffle furnace (Thermo-Fisher) and the thermostat was set to 290° C. to cause the carbon-iodine bond to undergo hemolytic cleavage, thereby forming the radical intermediate. The reaction between the radical intermediate and the porous graphitic carbon was allowed to proceed for 48-80 hrs to ensure a complete reaction. 2.16 grams of Hypercarb, 12.32 grams of a copper mesh, and 12 ml of heptadecafluoro-1-iodooctane.

The reaction product was removed from the reaction vessel and was placed into a vacuum oven and heated at 200° C. for 4 hours in order to evaporate any non bonded perfluorinated moieties from the surface of the functionalized graphitic stationary phase material.

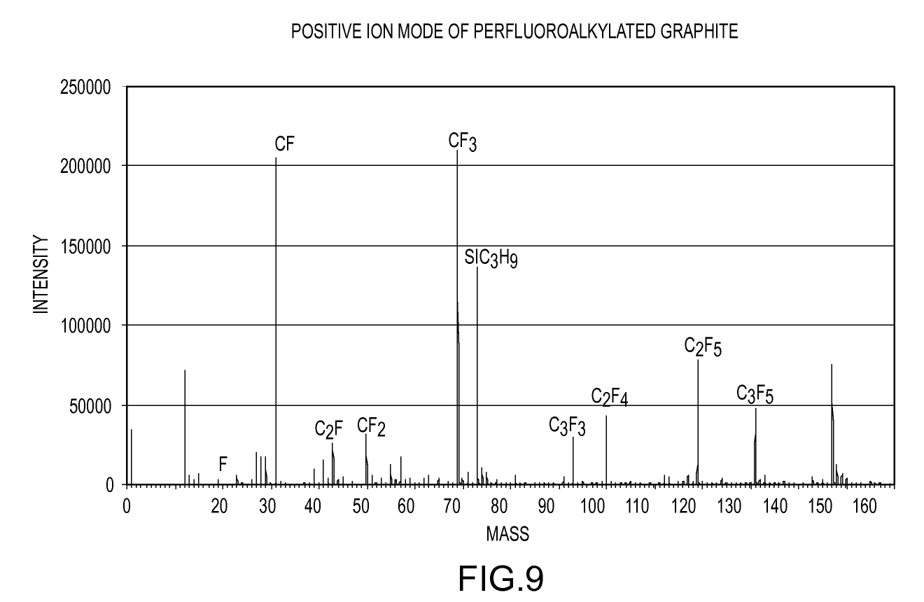

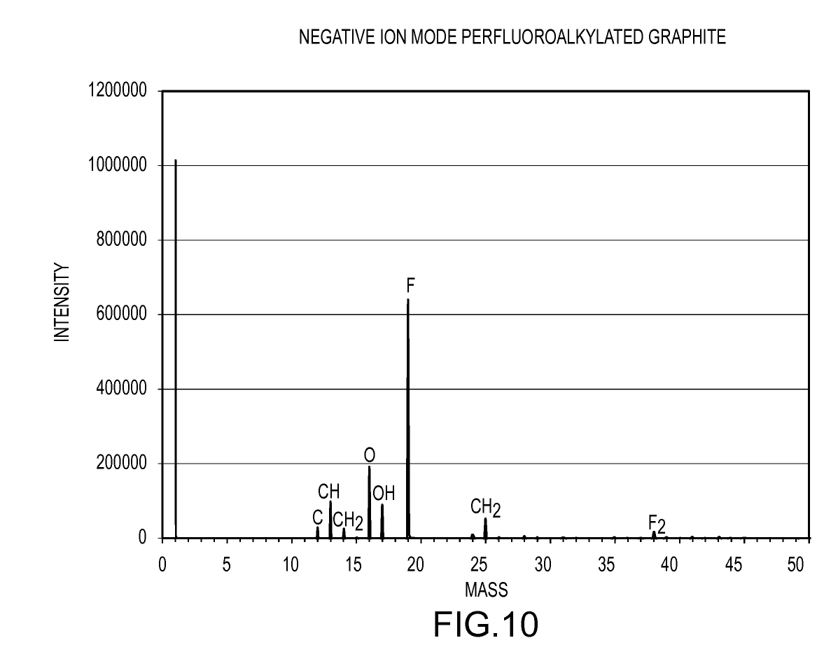

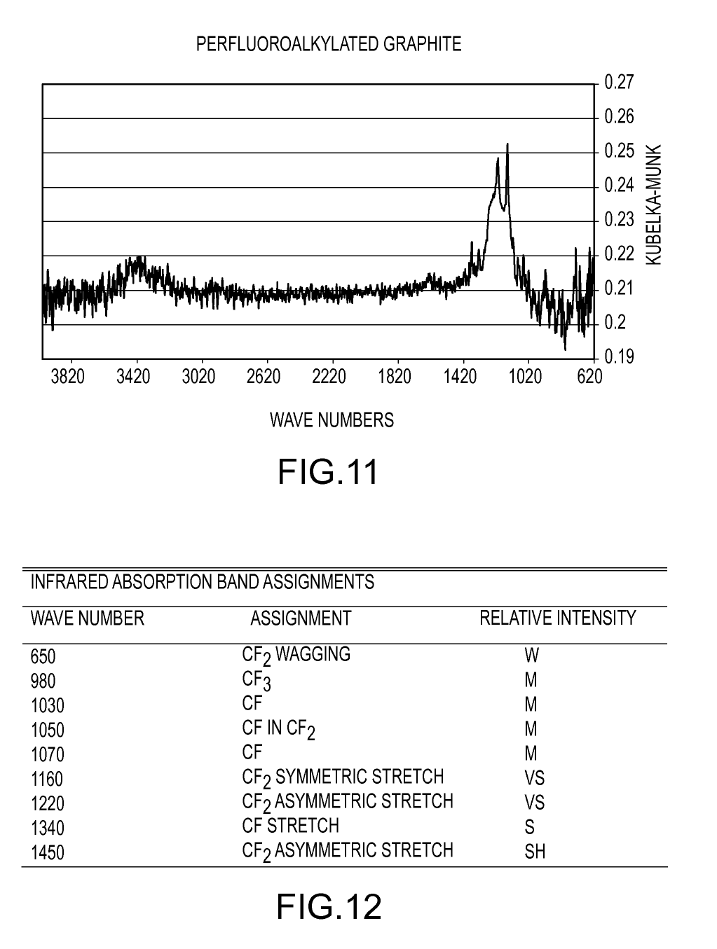

The resulting functionalized stationary phase product was characterized by ToF-SIMS (FIGS. 9-10) and DRIFT (FIG. 11). The ToF-SIMS analysis in static mode with a gallium primary ion source on the product revealed that there are perfluorinated moieties bonded to the porous graphitic carbon surface (FIG. 9). With the following peaks being characteristic of perfluorinated moieties: m/z=31 being CF, m/z=50 being CF₂, m/z=62 being C₂F₂, m/z=69 being CF₃, m/z=93 being C₃F₃, m/=100 being C₂F₄, m/z=119 being C₂F₅, and m/z=131 being C₃F₅. The negative ion mode spectra of the functionalized stationary phase product are indicative that fluorine is present in large quantities (FIG. 10). The presence of the fluorine peak establishes that there is fluorine present on the functionalized graphitic stationary phase surface.

The DRIFT spectrum of the functionalized graphitic stationary phase material is shown in FIG. 11. In generating the DRIFT spectra, the DRIFT cavity was purged with N₂ prior to sampling the functionalized graphitic stationary phase product. The DRIFT spectra shows a peak at 1210 cm⁻¹, which is indicative of a —CF₂— asymmetric stretch and another peak at 1150 cm⁻¹, which is indicative of a —CF₂— symmetric stretch.

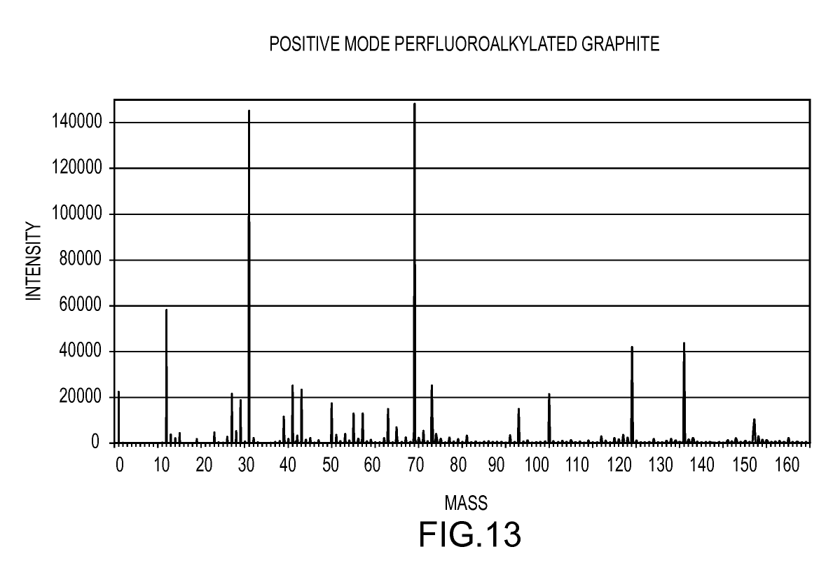

The results of the infrared spectroscopy analysis are shown in the table provided in FIG. 12, which confirms the presence of alkyl halide groups bonded to the surface of the porous graphitic carbon.

### Example 8

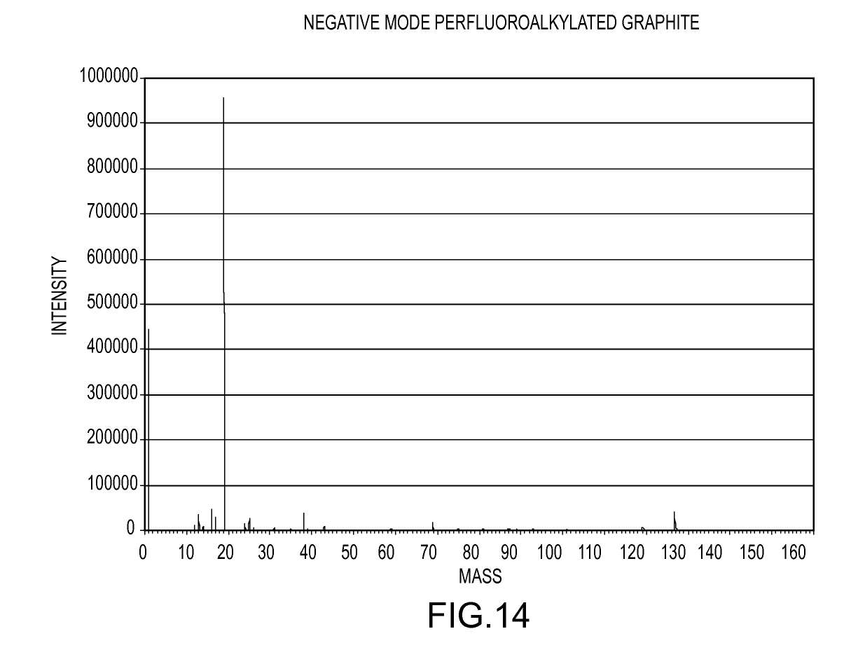

Example 8 describes the synthesis of a functionalized graphitic stationary phase material using heptadecafluoro-1-iodooctane. Example 8 was carried out using a similar process as Example 7, except that the vessel used was a thick walled glass vessel (Ace Glassware) and the reaction temperature was 260° C., instead of 290° C. The ToF-SIMS spectra for the perfluoroalkylated graphite sample prepared in Example 8 are shown in FIGS. 13-14, which show similar functionalization as the product of Example 7.

### VI. ADDITIONAL EMBODIMENTS

In additional embodiments, the functionalization of the porous graphitic carbon may be carried out using a different compound other than a radical forming agent. In one embodiment, the surface of the porous graphitic carbon may be modified by adsorbing a polypeptide to the surface of the porous graphitic carbon. The polypeptide may be from 5 amino acids residues in length, more specifically at least about 20, more specifically at least about 100, even more specifically at least about 1000. In one embodiment, the polypeptide may be cross linked. The cross-linked polypeptides may be cross linked through lysine residues in the polypeptide chain. In one embodiment, the polypeptides may be bonded to additional compounds or layers. For example, the polypeptide molecules may be bonded to streptavidin, bonded to avidin, be biotinylated, or combinations of the foregoing.

In another embodiment, the porous graphite surface is modified by a plurality of layers that are cationic and anionic. The layers may be deposited in a layer-by-layer fashion by adsorption of polyelectrolytes. The polyelectrolyte layers may be cross-linked.

In a further embodiment, the surface of the porous graphitic carbon may be modified using one or more radical producing agents and one or more monomers. The radical producing agent and the monomer are reacted together in the presence of the porous graphitic carbon to functionalize the surface thereof.

In yet another embodiment, an amine-containing polymer may be adsorbed onto the graphitic material to at least partially coat the interior and exterior surfaces thereof. For example, the amine-containing polymer may include, but is not limited to, poly(allylamine), poly(lysine), poly(ethylenimine), or combinations of the foregoing. The coated graphitic material may be thermally annealed and/or cross-linked with a compound such as diepoxide, a diacid chloride, diisocyanate, or combinations of the foregoing. After adsorption of the amine-containing polymer, the amine-containing polymer may be reacted with alkyl epoxides, acid chlorides, N-hydroxysuccinimidyl esters, or combinations of the foregoing to tailor the separation properties of the graphitic material.

While various aspects and embodiments have been disclosed herein, other aspects and embodiments are contemplated. The various aspects and embodiments disclosed herein are for purposes of illustration and are not intended to be limiting. Additionally, the words “including,” “having,” and variants thereof (e.g., “includes” and “has”) as used herein, including the claims, shall have the same meaning as the word “comprising” and variants thereof (e.g., “comprise” and “comprises”).

What is claimed is:

1. A method for manufacturing a functionalized graphitic stationary phase material suitable for use in a separation apparatus, comprising:
providing porous graphitic carbon having a porosity and surface area suitable for use as a stationary phase;
providing a functionalizing agent; and
functionalizing at least a portion of the surface area of the porous graphitic carbon by:
forming a radical from the functionalizing agent; and
bonding the radical to the porous graphitic carbon to yield the functionalized graphitic stationary phase material.

2. The method of claim 1, wherein the porous graphitic carbon comprises a plurality of graphitic particles exhibiting an average particle size of at least about 1 μm and a surface area of at least about 5.0 m²/g.

3. The method of claim 1, wherein the functionalizing agent comprises an alkyl halide.

4. The method of claim 3, wherein the alkyl halide comprises pentafluoroiodobenzene.

5. The method of claim 1, wherein the functionalizing agent comprises a member selected from the group consisting of aredi-tert-amylperoxide, azobisisobutyronitrile, benzoyl peroxide, diacyl peroxide, and combinations thereof.

6. The method as in claim 1, wherein forming a radical from the functionalizing agent comprises heating the functionalizing agent.

7. The method as in claim 6, wherein heating the functionalizing agent comprises heating the functionalizing agent to a temperature of at least about 200° C.

8. A functionalized graphitic stationary phase suitable for use in separation apparatus, comprising:
porous graphitic carbon having a porosity and surface area suitable for use as a stationary phase in a separation apparatus; and
a plurality of functional group molecules covalently bonded to the surface of the porous graphitic carbon, at least one of the plurality of functional group molecules including one or more alkyl groups.

9. The functionalized graphitic stationary phase as in claim 8, wherein at least a portion of the plurality of functional group molecules are bonded to the surface of the porous graphitic carbon through sp³ carbon-carbon bonds.

10. The functionalized graphitic stationary phase as in claim 8, wherein at least a portion of the plurality of functional group molecules comprise at least 4 atoms.

11. The functionalized graphitic stationary phase as in claim 8, wherein at least a portion of the plurality of functional group molecules comprise one or more heteroatoms bonded to the alkyl group.

12. The functionalized graphitic stationary phase as in claim 11, wherein at least a portion of the one or more heteroatoms are halogen atoms.

13. The functionalized graphitic stationary phase as in claim 8, wherein the one or more alkyl groups comprise a benzyl group.

14. The functionalized graphitic stationary phase as in claim 8, wherein the porous graphitic carbon comprises a plurality of graphitic particles exhibiting an average particle size in a range from about 1 μm to about 10 μm and a surface area of at least about 25 m²/g.

15. The functionalized graphitic stationary phase as in claim 8, wherein the porous graphitic carbon comprises a plurality of graphitic particles exhibiting an average particle size in a range from about 10 μm to about 150 μm and a surface area of at least about 10 m²/g.

16. A method for using a functionalized graphitic stationary phase, comprising:
providing a vessel packed with a functionalized porous graphitic carbon material, the porous graphitic carbon material including porous graphitic carbon with a plurality of functional group molecules covalently bonded to the surface of the porous graphitic carbon, at least one of the plurality of functional group molecules including one or more alkyl groups;
providing a mobile phase including at least two different components to be separated;
flowing the mobile phase through the functionalized porous graphitic material to at least partially separate the different components; and
recovering at least one of the two different components that have been separated.

17. The method as in claim 16, wherein at least a portion of the plurality of functional group molecules comprise at least 4 atoms.

18. The method as in claim 16, wherein the mobile phase has a pH greater than about 10 or less than about 2.

19. The method as in claim 16, wherein the at least one of the plurality of functional group molecules comprises one or more heteroatoms bonded to the alkyl group.

20. The method as in claim 20, wherein at least a portion of the one or more heteroatoms are halogen atoms.

21. A separation apparatus, comprising:
a vessel having an inlet and an outlet; and
a functionalized graphitic stationary phase packed within the vessel, the stationary phase including,
porous graphitic carbon having a porosity and surface area suitable for use as a stationary phase; and
a plurality of functional group molecules covalently bonded to the surface of the porous graphitic carbon, at least one of the plurality of functional group molecules including one or more alkyl groups.

22. The separation apparatus as in claim 21, wherein the at least one of the plurality of functional group molecules comprises an alkyl halide.

23. The separation apparatus as in claim 22, where the alkyl halide comprises a fluorinated benzene.

24. The separation apparatus as in claim 21, wherein the functional at least one of the plurality of functional group molecules is bonded to the surface of the porous graphitic carbon through sp³ carbon-carbon bonds.

25. The separation apparatus as in claim 21, wherein the vessel is configured as a chromatography column.

26. The separation apparatus as in claim 21, wherein the separation apparatus is a high performance liquid chromatography apparatus.
